(19) United States
(12) Patent Application Publication
(10) Pub. No.: US 2015/0086158 A1
(43) Pub. Date: Mar. 26, 2015

(54) Multi-Mode Phase-Shifting Interference Device

(71) Applicants: Mitsubishi Electric Corporation, Tokyo (JP); Mitsubishi Electric Research Laboratories, Inc., Cambridge, MA (US)

(72) Inventors: Keisuke Kojima, Westib, MA (US); Thakur Siddharth Singh, Saint James, NY (US); Toshiaki Koike-Akino, Salem, MA (US); Satoshi Nishikawa, Tokyo (JP); Bingnan Wang, Quincy, MA (US); Eiji Yagyu, Tokyo (JP)

(73) Assignees: Mitsubishi Electric Corporation, Tokyo (JP); Mitsubishi Electric Research Laboratories, Inc., Cambridge, MA (US)

(21) Appl. No.: 14/037,753

(22) Filed: Sep. 26, 2013

(51) Int. Cl. G02B 6/28

(52) U.S. Cl. CPC G02B 6/28
USPC 385/28

(57) ABSTRACT

A multi-mode interference (MMI) device includes a substrate layer, a core layer deposited on the substrate layer for propagating an optical signal, and a cladding layer deposited on the core layer for guiding the optical signal. The core layer includes a core section suitable for propagating multiple optical signals having different wavelengths. The core section includes a shifting segment for uniquely shifting phases of the multiple optical signals. The shifting segment includes at least one or a combination of sections having different effective refractive index, a tilted segment, a curved section, and waveguides with variations in width, thickness or effective refractive index.

### FIELD OF THE INVENTION

This invention relates generally to optical devices, and more particularly to multi-mode interference (MMI) devices for propagating and manipulating an optical signal.

### BACKGROUND OF THE INVENTION

In optical communications, optical signals with various wavelengths and polarizations can be multiplexed in a single optical carrier. Telecommunication networks are increasingly focusing on flexibility and configurability, which requires enhanced functionality of photonic integrated circuits (PICs) for optical communications, as well as compact devices. Optical devices based on multi-mode interference (MMI) have large bandwidth, are polarization insensitive, and have high fabrication tolerances.

For a number of applications, it is desired to minimize a length of the MMI device manipulating the optical signal. For example, in one MMI device, an indium gallium arsenide phosphide (InGaAsP) core, such as In₁₋ₓGaₓAs_{y}P_{1-y} is inserted between an indium phosphide (InP) substrate and an upper cladding.

The optical signal is highly concentrated in the core because the core has a high refractive index. The cladding, which has a relatively low refractive index, guides the optical signal along a depth of the device. The length L of the MMI device requires a sequential number of repetitions of the beat length for the low and high wavelengths. The beat length is defined as L_{π}=π/(β₀−β₁), where β₀ and β₁ are propagation constants of the first lowest order modes.

In order to split two different wavelengths λ₁ and λ₂, the self imaging theory of MMI waveguides requires the length of the MMI section L_{MMI} to satisfy

L_{MMI}=m×L(λ₁)=(m+1)×L_{π}(λ₂) (1)

where m is a positive integer. When L_{MMI} satisfies Equation (1), two images corresponding to each wavelength are formed at different positions along the width of the MMI waveguide (W_{M}) thus enabling separation of the wavelengths. Here L_{π} is the wavelength dependent beat length of the multimode region which can be approximated by

$${L}_{π} ( λ ) = \frac{4 {n}_{eff} {W}_{M}^{2}}{3 λ} \qquad ( 2 )$$

where n_{eff} is the effective refractive index which is in general also wavelength dependent. Equation (1) shows that for a given wavelength spacing Δλ

L_{MMI}∝1/Δλ. (3)

For typical MMI widths of 8 μm and Δλ of 4.5 nm, the corresponding MMI length for a typical 1.30458/1.30941 μm wavelength combiner is several tens of millimeters. However, the wavelength separation for 40/100G Ethernet is typically 20 nm or smaller. It is a challenging to combine and separate optical signals oscillating with similar wavelengths in a small device.

For example, one MMI-based wavelength splitter/combiner is described by Yao et al., in Optics Express vol. 20, No. 16, p. 18248 (2012). However, for operation of that device, wavelength separation has to be very large (such as 1.3 um and 1.55 um). Another optical manipulator is described by Jiao et al., in IEEE J. Quantum Electronics, Vol. 42, No. 3, p. 266 (2006). However, a method used by that manipulator only applies to photonic crystal. Such manipulators are difficult to manufacture.

Another MMI combiner is described in U.S. Pat. No. 6,580,844. However, that MMI combiner is designed to operate for a large wavelength separation of 240 nm (1.55/1.31 μm wavelength operation). Another method, described in U.S. Pat. No. 7,349,628, multiplexes or demultiplexes optical signals using an external control signal, which is not appropriate for some application.

There is a need to manipulate optical signals with multiple wavelengths or polarizations while reducing the length and complexity of fabrication of an optical device.

### SUMMARY OF THE INVENTION

Various embodiment of an invention are based on recognition that variations of a structure of in a core section of a multi-mode interference (MMI) device propagating the optical signals having different wavelengths affect the propagating signals differently. These variations of the structure include modifications varying an effective refractive index of the core section, as well as variations of width, thickness, material and shape of the core section.

These variations of the structure of the core section can be used to manipulate with phases of the propagating optical signals, and referred herein as structural phase shifting components. It was further realized that one or combination of the structural phase shifting components can be selected to achieve various splitting/combining tasks of the MMI.

Accordingly, one embodiment discloses a multi-mode interference (MMI) device including a substrate layer, a core layer deposited on the substrate layer for propagating an optical signal, and a cladding layer deposited on the core layer for guiding the optical signal. The core layer includes a core section suitable for propagating multiple optical signals having different wavelengths. The core section includes a shifting segment for uniquely shifting phases of the multiple optical signals. The shifting segment includes at least one or a combination of sections having different effective refractive index, a tilted segment, a curved section, and waveguides with variations in width, thickness or effective refractive index.

Another embodiment discloses a method for manipulating an optical signal according to a predetermined task by a multi-mode interference (MMI) device. The method includes determining a combination of structural phase shifting components manipulating differently multiple optical signals having different wavelength according to the predetermined task; and fabricating the MMI device having a substrate, a cladding layer and a core layer including a core section suitable, at any point, for propagating the multiple optical signals, wherein the core section includes the combination of structural phase shifting components.

### BRIEF DESCRIPTION OF THE DRAWINGS

FIG. 1A is an isometric view of an exemplar multi-mode interference (MMI) device in accordance with one embodiment of the invention;

FIG. 1B is a functional diagram of the MMI device according to some embodiments of the invention;

FIGS. 2A and 2B are top and cross-sectional view schematics of the MMI device according to one embodiment;

FIGS. 2C and 2D show variation of the MMI device according to different embodiments;

FIG. 3A is a top view of the MMI device according to one embodiment of the invention;

FIG. 3B is a top view of the MMI device according to another embodiment of the invention;

FIG. 4 is a top view of the MMI device having a patch with a different effective refractive index;

FIG. 5 is an embodiment having a core section that include multiple waveguides according to one embodiment of the invention; and

FIG. 6 is a top view of the MMI device with multiple output ports.

### DETAILED DESCRIPTION OF THE PREFERRED EMBODIMENT

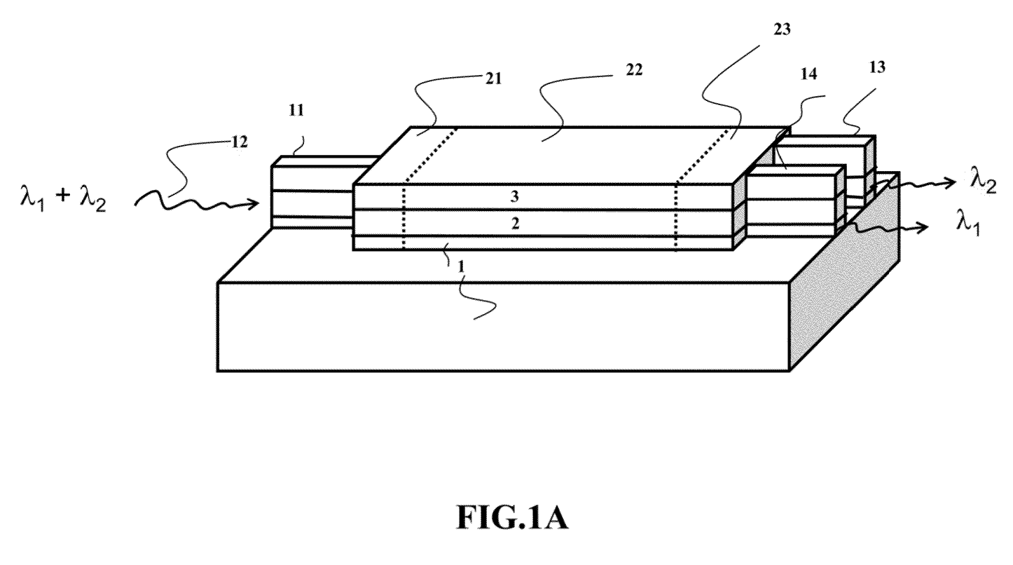

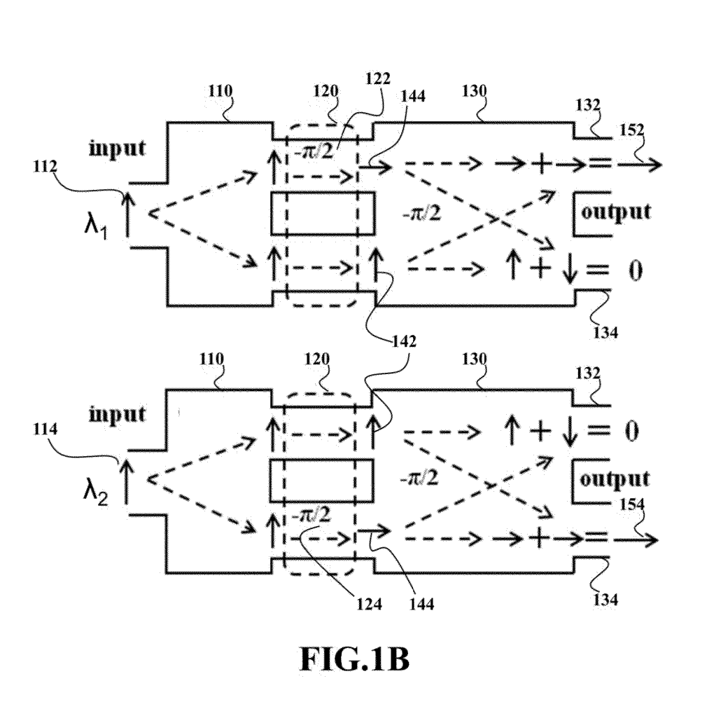

FIG. 1A shows an isometric view of an exemplar multi-mode interference (MMI) device manipulating the optical signal according to one embodiment of the invention. In this example, the MMI is a splitter for splitting two optical signals having different wavelengths. However, the principles employed by various embodiments are readily extended to splitting or combining arbitrarily number of optical signals.

The MMI device can be implemented as an epitaxial-grown structure having a substrate, a core and a cladding layer, as described below and shown in the figures. For example, in one embodiment, the MMI device is an indium phosphide (InP)/indium gallium arsenide phosphide (InGaAsP) structure, which includes an InP substrate, an InGaAsP core layer with As composition of, e.g., 60% lattice matched to InP, and InP cladding layer. In another embodiment, the MMI device can include a gallium arsenide (GaAs)/aluminum gallium arsenide (AlGaAs). Other variations are possible and within the scope of the embodiments of the invention.

For example, the MMI device of FIG. 1A includes a substrate layer, e.g., an InP layer 1, a core layer, e.g., an InGaAsP layer 2, grown or otherwise deposited on the substrate layer for propagating an optical signal, and a cladding layer, e.g., an InP layer 3, grown or otherwise deposited on the core layer for guiding the optical signal.

The MMI device can include an input section for accepting the multiple optical signals including a first signal having a first wavelength and a second signal having a second wavelength. For example, the input section can include an input waveguide 11 for imputing an optical signal 12. The MMI device can also include an output section having multiple output ports for outputting separately the first signal and the second signal. For example, the output section can include output waveguides 13 and 14 for outputting two signals. In one embodiment, the optical signal 12 includes two signals of different wavelengths. For example, the optical signal includes a first signal with a first wavelength λ₁ and a second signal with a second wavelength λ₂. In this embodiment, the predetermined task includes splitting the optical signal into the first signal and the second signal.

The core layer 2 of the MMI device can include several sections 21, 22, and 23. The sections can be uniform and non-uniform. The core section 22 is non-uniform and can have a shifting segment including a combination of structural phase shifting components to manipulate the optical signals of different wavelength. For example, the shifting segment can include at least one or combination of sections having different effective refractive index, a tilted segment, a curved section, and waveguides width or thickness variations. The uniform sections 21 and 23 can have small wavelength dependence. The section 21 is 1×N (N=1 or 2) beam splitter, and the section 23 is 2×2 beam splitter.

The predetermined task varies among embodiments. For example, in one embodiment, the predetermined task includes combining multiple signals into one signal. In another embodiment, the predetermined task includes combining or splitting multiple signals based on wavelength of the signals. Also, in various embodiments, the wavelength and/or polarization of the signals can vary.

Various embodiment of an invention are based on recognition that optical signals of different wavelength are affected differently by a change of effective refractive index in a core section of a multi-mode interference (MMI) device propagating the optical signals having different wavelengths, or variation of width, thickness, material and shape of the core section. These variations of the structure of the core section can be used to manipulate phases of the propagating optical signals, and referred herein as structural phase shifting components. It is further realized that one or combination of the structural phase shifting components can be selected to achieve various splitting/combining tasks of the MMI.

FIG. 1B shows a functional diagram of the MMI device of FIG. 1A according to some embodiments of the invention. The MMI device includes an input section 110, a core section with a shifting segment 120, and an output section 130. An optical signal including a first signal 112 with a first wavelength and a second signal 114 with a second wavelength is coupled into the input section 110 and split using the shifting segment 120 into two arms 132 and 134 of the output section 130 with, e.g., equal phase and equal power. In some variations, the input section includes 1×2 MMI coupler, i.e., i.e., an input signal is split into 2 outputs, and the output section includes 2×2 MMI coupler, i.e., a coupler with two input signals and two output signals and each input signal is split into two outputs.

The phase shift 120 section is designed to add, for example, an extra −π/2 phase shift 122 to the first signal 112 in the upper arm and an extra −π/2 phase shift 124 to the second signal 114 in the lower arm. When the electric fields from both arms are combined in the output section, the electric field in one output coming from the cross arm 142 (e.g., the field in upper output from the lower arm, or the field in the lower output from upper arm) has an extra −π/2 phase shift compared with that from the bar arm 144 (e.g., field upper output from upper arm or field lower output from lower arm).

The interference between electric fields with different phases cause the first signal into the upper output arm 132, whereas the second signal is forced into the lower output arm 134. Accordingly, a combination of the two optical signals having different wavelengths are split into a first signal 152 having the first wavelength and a second signal 154 having the second wavelength.

The phase shifting segment can be implemented using various techniques. For example, in one embodiment, the shifting segment shifts phases of the first and the second components of the optical signal are based on a change of effective refractive index in a non-uniform core section of a multi-mode interference (MMI) device. For example, the change of the effective refractive index can be implemented by varying width, thickness, material of the core section. In some variations of these embodiments, the change of the effective refractive index is combined with variations in the shape of the core section. For example, in some embodiments, the shape of the core section is modified to include a tilted or a curved segment.

Some embodiments determine a combination of structural phase shifting components manipulating differently multiple optical signals having different wavelength according to the predetermined task. Next, the MMI device is fabricated with the core section that includes the combination of structural phase shifting components.

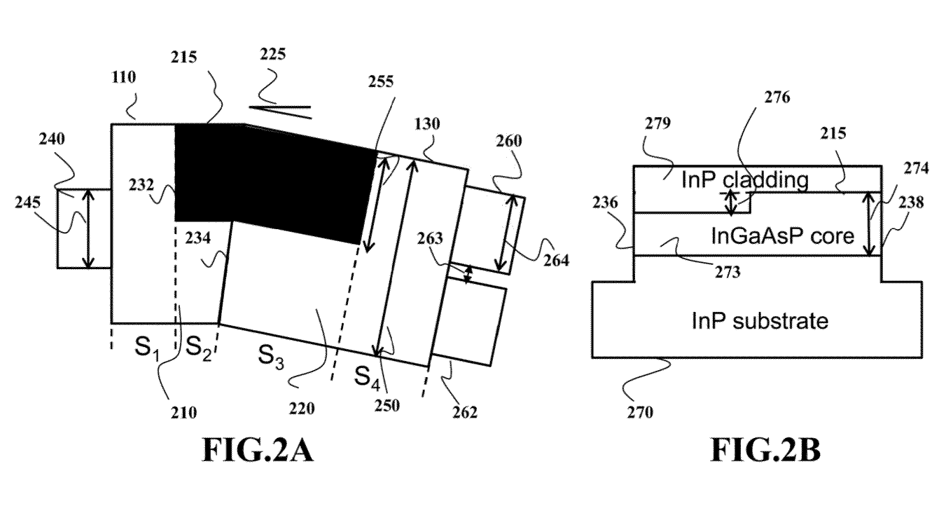

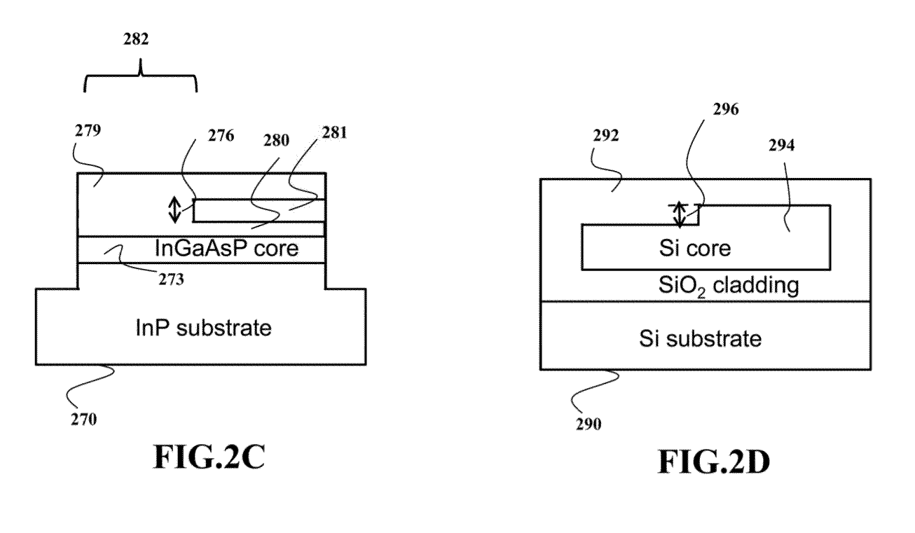

FIGS. 2A and 2B are schematics of the MMI device according to one embodiment. FIG. 2A shows a top view of the MMI device. FIG. 2B shows a cross-section along an edge 234. In this embodiment, the shifting segment includes a tilted section partially modified by a patch. For example, the shifting segment includes a first shifting segment 210 arranged in parallel with the input section 110 and a second shifting segment 220 arranged in parallel with the output section 130. In this embodiment, the first and the second shifting segments are tilted 225 with respect to each other and a portion of the shifting segment includes the patch 215. Typically, the patch 215 includes is etched from the core layer and/or include material with different refractive index than at least other parts of the core layer. Alternatively, the thickness of the cladding layer 279 can be changed, or there are many variations to vary the local effective refractive index. The tilt 225 in combination with the patch 215 creates the structural phase shifting effect leading to the functionality described above.

In various embodiments, the parallel and tilted arrangements of the sections of the MMI device are achieved by orienting lateral and end edges of the sections. For example, each section of the MMI device includes two lateral edges, e.g., edges 236 and 238 and two end edges, e.g., edges 232 and 234.

The sections are typically connected by corresponding lateral edges, and end edges of the sections can form edges of the MMI device. Accordingly, the sections are arranged such that the end edges of the first shifting segment form straight angles with end edges of the input section, the end edges of the second shifting segment form straight angles with the end edges of the output section. In contrast, the end edges of the first shifting segment form acute or obtuse angles with the end edges of the second shifting segment, i.e., these sections are tilted.

In various embodiments the edges of the shifting segment does not form parallel angles with the input/output edges of the MMI, i.e., they can be slanted or tapered, in order to improve optical coupling efficiency

In various embodiments the shifting segment is integrated into the core section of the MMI device, which reduces the length of the MMI device. The material and dimensions of the shifted section and the patch in an upper part of the shifting segment are selected to add an extra −θ−π/2 phase shift to the first signal with first wavelength in the upper part or an extra θ−π/2 phase shift to the second signal with the second wavelength in the lower part of the shifting segment. The constant phase, θ, can be set to 0 by adjusting the tilted angle. Typically, the adjusting is made in the design stage of fabricating MMI device. Additionally or alternatively, adjusting of the tilted angle can be made by locally changing the refractive index by applying an electric field or heating.

One variation of this embodiment has the following geometrical parameters. These parameters are provided for example purposes. An input waveguide 240 has a width 245 of Wᵢₙₚᵤₜ=2.5 μm. The multimode MMI device includes four sections, S₁, S₂, S₃, and S₄. The S₁ and S₄ sections, i.e., the input and the output sections, do not include the non-uniform refractive index part, whereas the upper parts of the S₂ and S₃ sections, i.e., the first and the second parts of the shifting segment, are etched. The S₂ and S₃ sections are joined by angled tilt 225 by a pre-determined angle, typically −2 to 2 degrees, depending on the two wavelengths. The MMI device has a width 250 of W_{MMI}=6 μm and a total length of L=1490 μm. The patch region has a width 255 of Wₚ=3.65 μm and a length of S₂+S₃=1171 μm in total. Specific selection of S₂ and S₃ does not have a strong effect on the performance, but typically S₂ is equal to S₃. The lengths of the St and S₄ section are 100 μm and 119 μm, respectively. Both the upper output arm 260 and the lower output arm 262 have a width 264 of 2.5 μm and are placed with a gap 263 of 1 μm.

The device is built on Indium Phosphide (InP) substrate 270 In₁₋ₓGaₓAs_{y}P_{1-y} (y=0.4) as waveguide core 273b with a thickness 274 of 0.5 μm and 1 μm thick InP cladding layer. Also, even though FIG. 2B shows that the core section 275 of the waveguide is etched by the thickness 276 of 0.2 μm, other embodiments use the core sections or layer with different material composition, or different cladding layer thickness.

FIG. 2C shows a variation where InGaAsP core layer 273, a InP etch stopper layer 280, and an InGaAsP upper core layer 280 are deposited on top of a InP substrate 270. In this case, a patch area 282 is created by etching the InGaAsP upper core layer 281 till the InP etch stopper layer 280. Therefore, the InGaAsP upper core layer thickness 276 is not influenced by the etching process variations, and manufacturing repeatability increases. The InP cladding covers the upper cladding layer and the etched patch 282.

FIG. 2D shows an embodiment of the MMI device built on a Si substrate 290, and the Si core layer 294 is surrounded by silicon dioxide SiO₂ cladding layer 292. The non-uniform core section is formed using a step 296.

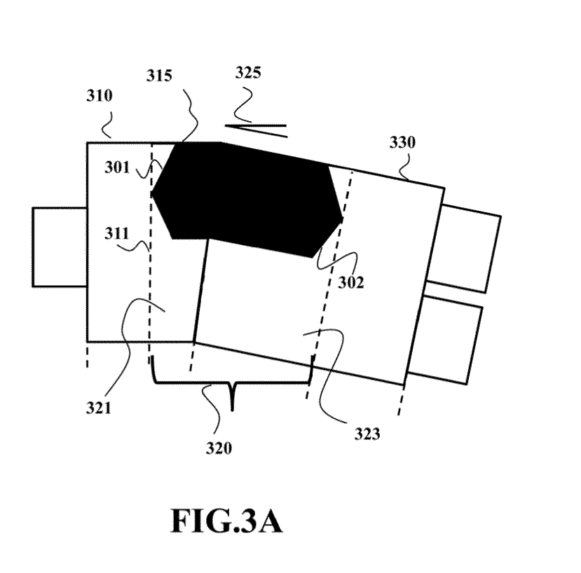

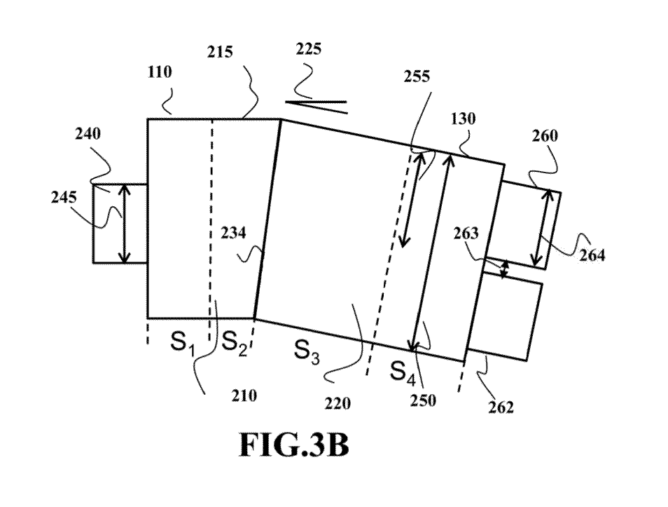

FIG. 3A shows an embodiment where the front edge 301 and end edge 302 of the patches are tapered or slated. The benefit compared to the straight edge is that mode propagation is smoother and propagation efficiency is higher.

In this embodiment, the core layer includes a first uniform section 310, a second uniform section 330, and the core section 320. Each of the first uniform section, the second uniform section and the core section of the MMI device has two lateral edges and two end edges. The sections are connected by corresponding lateral edges, e.g., an edge 311. The end edges of the sections form edges of the MMI device. The core section includes a patch 315 having a material with an effective refractive index different from a material of an area bordering the patch. The patch has lateral and end edges, and wherein the lateral edges of the patch are tapered. Other variations of the shape of the patch 315 are possible. The core portion can also include a tilt 315.

FIG. 3B shows an embodiment with uniform effective refractive index, wherein the manipulations of the signals are performed by the tilt 225. Some variations of this embodiment select parameters of the MMI device to form a wavelength splitter/combiner. The benefit of this structure is the relative simplicity of fabrication.

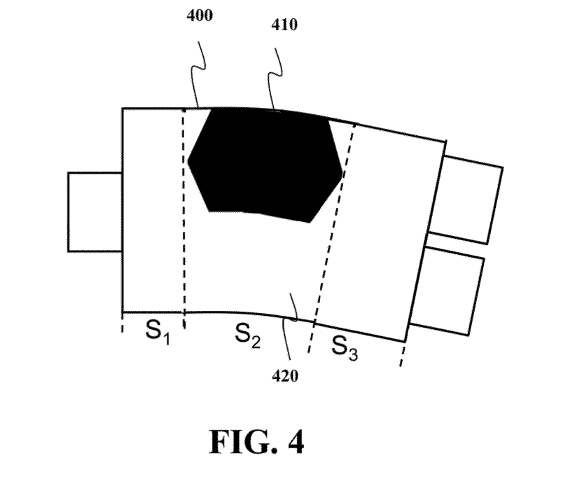

FIG. 4 shows an embodiment having a core section 400 of the MMI device that includes a patch 410 having a different effective refractive index from the surrounding regions 420 of the core section. In the embodiment of FIG. 4, the core section 400 is curved. In alternative embodiments, the core section can have different shapes.

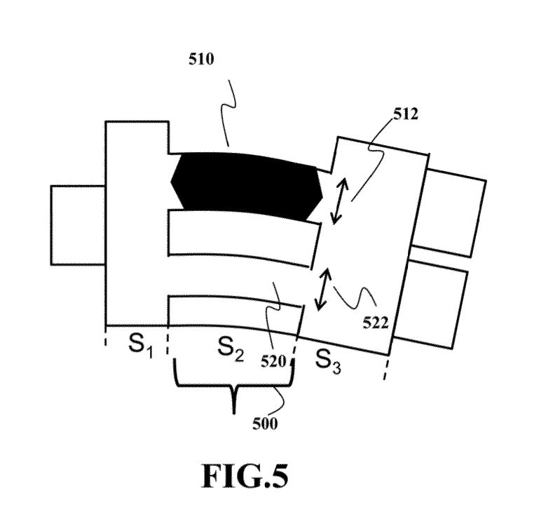

FIG. 5 shows an embodiment with the core section that includes multiple waveguides having variations of at least one of a width, a thickness of an effective refractive index of a material of a waveguide. For example, the embodiment of FIG. 5 includes two waveguides 510 and 520. The waveguide 510 can have the effective refractive index different than the effective refractive index of the waveguide 520. The widths 512 and 522 of the waveguides can also be different to further increase the difference in effective refractive index. The phase shift section 500 can contain a tilt and/or curved waveguides.

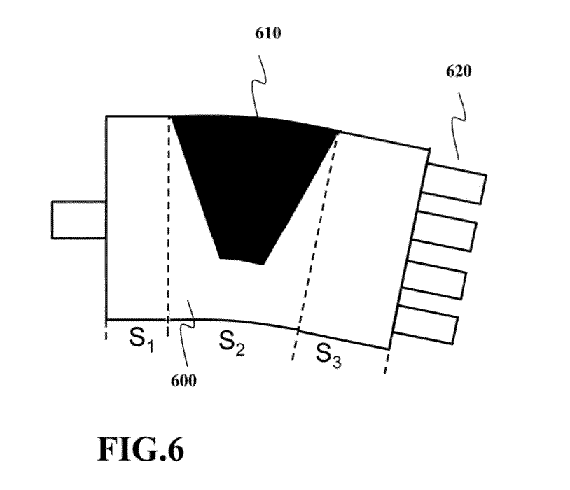

FIG. 6 shows a variation where more than two output ports 620. The phase shift section 600 includes an area 610 which has different effective refractive index compared to the surrounding area. The phase shift section 600 can contain a tilt and/or curved perimeters. The shape of the area 610 can vary.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A multi-mode interference (MMI) device, comprising:
a substrate layer;
a core layer deposited on the substrate layer for propagating an optical signal; and
a cladding layer deposited on the core layer for guiding the optical signal, wherein the core layer includes a core section suitable for propagating multiple optical signals having different wavelengths, wherein the core section includes a shifting segment for uniquely shifting phases of the multiple optical signals, wherein the shifting segment includes at least one or a combination of sections having different effective refractive index, a tilted segment, a curved section, and waveguides with variations in width, thickness or effective refractive index.

2. The MMI device of claim 1, wherein the MMI device manipulates the optical signal according to a predetermined task, and wherein a combination of structural phase shifting components of the shifting is optimized for the predetermined task.

3. The MMI device of claim 2, wherein the predetermined task includes splitting the multiple optical signals or combining the multiple optical signals.

4. The MMI device of claim 2, wherein the shifting segment includes a tilted section having a first part and a second part, and wherein at least a portion of the second part of the tilted section is modified with a patch changing an effective refractive index in the core section.

5. The device of claim 4, wherein the multiple optical signal includes a first signal having a first wavelength and a second signal having a second wavelength, wherein the first part of the shifting segment adds a −π/2 phase shift to the first signal, and the second part of the shifting segment adds a −π/2 phase shift to the second signal.

6. The MMI device of claim 1, further comprising:
an input section for accepting the multiple optical signals including a first signal having a first wavelength and a second signal having a second wavelength; and
an output section having multiple output ports for outputting separately the first signal and the second signal.

7. The device of claim 6, wherein the input section includes a 1×2 MMI coupler, and the output section includes a 2×2 MMI coupler.

8. The MMI device of claim 6, wherein the shifting segment includes a first shifting segment arranged in parallel with the input section and a second shifting segment arranged in parallel with the output section, wherein the second shifting segment is tilted with respect to the first shifting segment, and wherein a portion of the shifting segment includes a patch of material having an effective refractive index different from a material bordering the patch.

9. The MMI device of claim 1, wherein the core layer includes a first uniform section and a second uniform section, wherein each of the first uniform section, the second uniform section and the core section of the MMI device has two lateral edges and two end edges, wherein the sections are connected by corresponding lateral edges, and the end edges of the sections form edges of the MMI device, wherein the core section include a patch having a material with an effective refractive index different from a material of an area bordering the patch, wherein the patch has lateral and end edges, and wherein the lateral edges of the patch are tapered.

10. The MMI device of claim 1, wherein the core section includes multiple waveguides having variations of at least one of a width, a thickness of an effective refractive index of a material of a waveguide.

11. A method for manipulating an optical signal according to a predetermined task by a multi-mode interference (MMI) device, comprising:
determining a combination of structural phase shifting components manipulating differently multiple optical signals having different wavelength according to the predetermined task; and
fabricating the MMI device having a substrate, a cladding layer and a core layer including a core section suitable, at any point, for propagating the multiple optical signals, wherein the core section includes the combination of structural phase shifting components.

12. The method of claim 11, wherein the structural phase shifting components are selected from a group consisting of sections having different effective refractive index, a tilted segment, a curved section, and width or thickness variations.

13. The method of claim 11, wherein the MMI has multiple core layers and cladding layers, and part of the upper core layer is etched to create difference in effective refractive index.

14. The method of claim 11, wherein the core layer includes an indium gallium arsenide phosphide (InGaAsP) material, and the substrate and the cladding layer includes an indium phosphide (InP) material.

15. The method of claim 11, wherein the core layer and the substrate includes a Si material, and the cladding layer includes silicon dioxide.
